(19) United States
(12) Patent Application Publication
(10) Pub. No.: US 2010/0261606 A1
(43) Pub. Date: Oct. 14, 2010

(54) Homogeneous and Storage-Stable Mixtures of Different Active Plant Protection Agent Granule Particles

(75) Inventors: Smita Patel, Eppstein-Bremthal (DE); Mohammad Atiur Rahman, Frankfurt (DE)

Correspondence Address: Baker Donelson Bearman, Caldwell & Berkowitz, PC, 920 Massachusetts Ave, NW, Suite 900, Washington, DC, 20001, US

(73) Assignee: BAYER CROPSCIENCE AG, Monheim (DE)

(21) Appl. No.: 12/741,192

(22) PCT Filed: Oct. 28, 2008
(86) PCT No.: PCT/EP2008/009083

§ 371 Date: May 27, 2010

(30) Foreign Application Priority Data
Nov. 6, 2007 (EP) 07021525.6
Oct. 28, 2008 (EP) PCT/EP2008/009083

(51) Int. Cl. A01N 25/12; A01N 43/824; A01N 25/32

(52) U.S. Cl. 504/103; 504/263; 424/405

(57) ABSTRACT

The use of mixtures of different plant protectant active substance granule particles which remain homogeneous upon storage, handling and application, for the stable storage of mixing-incompatible active substances, and a preparation process therefor.

The present patent application relates to the use of mixtures of different plant protectant active substance granule particles with a spherical to lump-like shape which remain homogeneous upon storage, handling and application, for the stable storage of mixing-incompatible active substances. The application likewise relates to a process for the preparation of mixtures of plant protectant active substances in the form of granules for mixing-incompatible active substances.

Granule particles of plant protectant active substances will, in the case of water-dispersible granules (WG), disintegrate in the spray tank water with formation of a fine dispersion of primary particles, which can be applied to crops by spraying. In addition, plant protectant active substance granule particles as other formulation types of granules may, however, also be fully water-soluble or may be capable of being applied in the dry state.

Agriculture frequently requires more than one plant protectant active substance, hereinbelow also referred to as simply “active substance”, in order to treat a specific crop. Thus, when treating crops, for example by spraying, it is desirable to apply the multiple combination of active substances if at all possible simultaneously in one pass instead of carrying out separate passes across the field with the respective individual active substances. Thus, there has been a variety of approaches in the field of granule application to produce a multiple combination of plant protectant active substances.

One approach is the mechanical mixture of granule particles which comprise in each case only one specific active substance. With these granule “mixture packs”, there is, however, always the risk of separation, which is not a problem per se if the entire contents of the pack are always used. If, however, only parts of the pack content are placed into the spray tank, previous mechanical separation of the pack content, for example during storage and handling, may result in grave dosage errors. Solutions to this problem are shown in, inter alia, WO 94/24861 A1, JP 2004352711 A and WO 97/00608 A1, where mention is made of the correct granule particle size and its distribution in the pack contents. WO 97/00608 A1 also deals with the importance of granule shape and provides granule particles with a “cylindrical shape”, prepared by extrusion methods, more advantageously as granule particles with a “spherical to lump-like (isodimensional) shape”, prepared by agglomeration methods such as fluidized-bed or high-shear methods.

An approach which reliably avoids the risk of separation is the preparation and use of granule particles which already bear within or on each individual granule particle a multiple combination of a plurality of plant protectant active substances in the desired concentrations and mixing ratios. However, these granule “coformulations” greatly reduce the flexibility with regard to the specific requirements of the various crops and markets. The selection of the active substance combinations for the individual active substance mixtures required, and their concentrations and mixing ratios, increases the number of these coformulations to be provided, which, in turn, results in complicated preparation and storage problems. Besides, a serious problem which has emerged in practice is that certain active substances have proved to be mixing-incompatible in a granule coformulation, i.e. that they degrade in combination with other active substances and can therefore not be coformulated in a storage-stable manner.

It was an object of the present invention to provide advantageous combinations of a plurality of plant protectant active substances in granule form, in which combinations mixing-incompatible active substances can be stored in a storage-stable manner.

It has now been found that the object of the present invention is achieved by the use of purely mechanical mixtures of active substance granule particles with a spherical to lump-like shape which no longer separate mechanically, that is to say which always remain homogeneous upon storage, handling and application, whereby a reproducible composition is always ensured, even when only some of the pack contents are removed, with the surprising effect that active substances which are mixing-incompatible with each other can thereby be stored stably together (i.e. for example that active substances which react chemically with each other can no longer decompose each other upon storage).

The present invention therefore relates to the use of mixtures of different plant protectant active substance granule particles with a spherical to lump-like shape which remain homogeneous upon storage, handling and application, for the stable storage of mixing-incompatible active substances.

According to the present invention, the mixture of different plant protectant active substance granule particles consists of a mixture (pack) of at least two groups of granule particles. One group of granule particles may comprise one or more plant protectant active substances, while the other group(s) of granule particles can either also comprise one or more plant protectant active substances and/or other substances such as, for example, customary additives and auxiliaries such as, for example, adjuvants, fertilizers, penetrants, stabilizers.

In addition, the invention equally also relates to a process for the preparation of mixtures of plant protectant active substances in the form of granules for mixing-incompatible active substances, where the mixing-incompatible active substances, alone or together with mixing-compatible active substances, are initially in each case separately formulated as granule particles of one group, which are then subsequently mixed with each another.

The term plant protectant active substances refers to agrochemical active substances such as, for example, herbicides, safeners, fungicides and insecticides. Examples of suitable plant protectant active substances include the following, without being limited thereto, where hereinbelow the term herbicides comprises not only herbicides, but also plant growth regulators, the term fungicides not only fungicides, but also bactericides and viricides, and the term insecticides not only insecticides, but also acaricides (miticides), nematicides, molluscicides, rodenticides and repellents (antifeedants), unless otherwise suggested by the context.

Herbicides which can be employed are, for example, known active substances which are based on the inhibition of, for example, acetolactate synthase, acetyl-CoA carboxylase, cellulose synthase, enolpyruvylshikimate 3-phosphate synthase, glutamine synthetase, p-hydroxyphenylpyruvate dioxygenase, phytoene desaturase, photosystem I, photosystem II, protoporphyrinogen oxidase, as they are known, for example, from Weed Research 26 (1986) 441-445 or the textbook “The Pesticide Manual”, 12th Edition 2000, 13th Edition 2003 or 14th Edition 2006/2007, or as they are described in the corresponding “e-Pesticide Manual”, version 4 (2006), in each case edited by the British Crop Protection Council, and the literature cited therein. Known herbicides or plant growth regulators which may be used in the present invention and which must be mentioned are, for example, the following active substances (the compounds are either described by the “common name” according to the International Organization for Standardization (ISO) or by the chemical name or by the code number) and always comprise all use forms such as acids, salts, esters and isomers such as stereoisomers and optical isomers. In this context, one and in some cases also a plurality of use forms are mentioned, by way of example: acetochlor, acibenzolar, acibenzolar-S-methyl, acifluorfen, acifluorfen-sodium, aclonifen, alachlor, allidochlor, alloxydim, alloxydim-sodium, ametryn, amicarbazone, amidochlor, amidosulfuron, aminopyralid, amitrole, ammonium sulfamate, ancymidol, anilofos, asulam, atrazine, azafenidin, azimsulfuron, aziprotryn, BAH-043, BAS-140H, BAS-693H, BAS-714H, BAS-762H, BAS-776H, BAS-800H, beflubutamid, benazolin, benazolin-ethyl, bencarbazone, benfluralin, benfuresate, bensulide, bensulfuron-methyl, bentazone, benzfendizone, benzobicyclon, benzofenap, benzofluor, benzoylprop, bifenox, bilanafos, bilanafos-sodium, bispyribac, bispyribac-sodium, bromacil, bromobutide, bromofenoxim, bromoxynil, bromuron, buminafos, busoxinone, butachlor, butafenacil, butamifos, butenachlor, butralin, butroxydim, butylate, cafenstrole, carbetamide, carfentrazone, carfentrazone-ethyl, chlomethoxyfen, chloramben, chlorazifop, chlorazifop-butyl, chlorbromuron, chlorbufam, chlorfenac, chlorfenac-sodium, chlorfenprop, chlorflurenol, chlorflurenol-methyl, chloridazon, chlorimuron, chlorimuron-ethyl, chlormequat-chloride, chlornitrofen, chlorophthalim, chlorthal-dimethyl, chlorotoluron, chlorsulfuron, cinidon, cinidon-ethyl, cinmethylin, cinosulfuron, clethodim, clodinafop clodinafop-propargyl, clofencet, clomazone, clomeprop, cloprop, clopyralid, cloransulam, cloransulam-methyl, cumyluron, cyanamide, cyanazine, cyclanilide, cycloate, cyclosulfamuron, cycloxydim, cycluron, cyhalofop, cyhalofop-butyl, cyperquat, cyprazine, cyprazole, 2,4-D, 2,4-DB, daimuron/dymron, dalapon, daminozide, dazomet, n-decanol, desmedipham, desmetryn, detosyl-pyrazolate (DTP), di-allate, dicamba, dichlobenil, dichlorprop, dichlorprop-P, diclofop, diclofop-methyl, diclofop-P-methyl, diclosulam, diethatyl, diethatyl-ethyl, difenoxuron, difenzoquat, diflufenican, diflufenzopyr, diflufenzopyr-sodium, dimefuron, dikegulac-sodium, dimefuron, dimepiperate, dimethachlor, dimethametryn, dimethenamid, dimethenamid-P, dimethipin, dimetrasulfuron, dinitramine, dinoseb, dinoterb, diphenamid, dipropetryn, diquat, diquat-dibromide, dithiopyr, diuron, DNOC, eglinazine-ethyl, endothal, EPTC, esprocarb, ethalfluralin, ethametsulfuron-methyl, ethephon, ethidimuron, ethiozin, ethofumesate, ethoxyfen, ethoxyfen-ethyl, ethoxysulfuron, etobenzanid, F-5331, i.e. N-[2-chloro-4-fluoro-5-[4-(3-fluoropropyl)-4,5-dihydro-5-oxo-1H-tetrazol-1-yl]-phenyl]ethanesulfonamide, fenoprop, fenoxaprop, fenoxaprop-P, fenoxaprop-ethyl, fenoxaprop-P-ethyl, fentrazamide, fenuron, flamprop, flamprop-M-isopropyl, flamprop-M-methyl, flazasulfuron, florasulam, fluazifop, fluazifop-P, fluazifop-butyl, fluazifop-P-butyl, fluazolate, flucarbazone, flucarbazone-sodium, flucetosulfuron, fluchloralin, flufenacet (thiafluamide), flufenpyr, flufenpyr-ethyl, flumetralin, flumetsulam, flumiclorac, flumiclorac-pentyl, flumioxazin, flumipropyn, fluometuron, fluorodifen, fluoroglycofen, fluoroglycofen-ethyl, flupoxam, flupropacil, flupropanate, flupyrsulfuron, flupyrsulfuron-methyl-sodium, flurenol, flurenol-butyl, fluridone, fluorochloridone, fluoroxypyr, fluoroxypyr-meptyl, flurprimidol, flurtamone, fluthiacet, fluthiacet-methyl, fluthiamide, fomesafen, foramsulfuron, forchlorfenuron, fosamine, furyloxyfen, gibberellic acid, glufosinate, L-glufosinate, L-glufosinate-ammonium, glufosinate-ammonium, glyphosate, glyphosate-isopropylammonium, H-9201, halosafen, halosulfuron, halosulfuron-methyl, haloxyfop, haloxyfop-P, haloxyfop-ethoxyethyl, haloxyfop-P-ethoxyethyl, haloxyfop-methyl, haloxyfop-P-methyl, hexazinone, HNPC-9908, HOK-201, HW-02, imazamethabenz, imazamethabenz-methyl, imazamox, imazapic, imazapyr, imazaquin, imazethapyr, imazosulfuron, inabenfide, indanofan, indoleacetic acid (IAA), 4-indol-3-ylbutyric acid (IBA), iodosulfuron, iodosulfuron-methyl-sodium, ioxynil, isocarbamid, isopropalin, isoproturon, isouron, isoxaben, isoxachlortole, isoxaflutole, isoxapyrifop, KUH-043, KUH-071, karbutilate, ketospiradox, lactofen, lenacil, linuron, maleic hydrazide, MCPA, MCPB, MCPB-methyl, -ethyl and -sodium, mecoprop, mecoprop-sodium, mecoprop-butotyl, mecoprop-P-butotyl, mecoprop-P-dimethylammonium, mecoprop-P-2-ethylhexyl, mecoprop-P-potassium, mefenacet, mefluidide, mepiquat-chloride, mesosulfuron, mesosulfuron-methyl, mesotrione, methabenzthiazuron, metam, metamifop, metamitron, metazachlor, methazole, methiozolin (MRC-01, EK-5229), methoxyphenone, methyldymron, 1-methylcyclopropen, methyl isothiocyanate, metobenzuron, metobenzuron, metobromuron, metolachlor, S-metolachlor, metosulam, metoxuron, metribuzin, metsulfuron, metsulfuron-methyl, molinate, monalide, monocarbamide, monocarbamide-dihydrogensulfate, monolinuron, monosulfuron, monuron, MT 128, MT-5950, i.e. N-[3-chloro-4-(1-methylethyl)-phenyl]-2-methylpentanamide, NGGC-011, naproanilide, napropamide, naptalam, NC-310, i.e. 4-(2,4-dichlorobenzoyl)-1-methyl-5-benzyloxypyrazole, neburon, nicosulfuron, nipyraclofen, nitralin, nitrofen, nitrophenolate-sodium (isomer mixture), nitrofluorfen, nonanoic acid, norflurazon, orbencarb, orthosulfamuron, oryzalin, oxadiargyl, oxadiazon, oxasulfuron, oxaziclomefone, oxyfluorfen, paclobutrazole, paraquat, paraquat-dichloride, pelargonic acid (nonanoic acid), pendimethalin, pendralin, penoxsulam, pentanochlor, pentoxazone, perfluidone, pethoxamid, phenisopham, phenmedipham, phenmedipham-ethyl, picloram, picolinafen, pinoxaden, piperophos, pirifenop, pirifenop-butyl, pretilachlor, primisulfuron, primisulfuron-methyl, probenazole, profluazole, procyazine, prodiamine, prifluraline, profoxydim, prohexadione, prohexadione-calcium, prohydrojasmone, prometon, prometryn, propachlor, propanil, propaquizafop, propazine, propham, propisochlor, propoxycarbazone, propoxycarbazone-sodium, propyzamide, prosulfalin, prosulfocarb, prosulfuron, prynachlor, pyraclonil, pyraflufen, pyraflufen-ethyl, pyrasulfotole, pyrazolynate (pyrazolate), pyrazosulfuron-ethyl, pyrazoxyfen, pyribambenz, pyribambenz-isopropyl, pyribenzoxim, pyributicarb, pyridafol, pyridate, pyriftalid, pyriminobac, pyriminobac-methyl, pyrimisulfan, pyrithiobac, pyrithiobac-sodium, pyroxasulfone, pyroxsulam, quinclorac, quinmerac, quinoclamine, quizalofop, quizalofop-ethyl, quizalofop-P, quizalofop-P-ethyl, quizalofop-P-tefuryl, rimsulfuron, secbumeton, sethoxydim, siduron, simazine, simetryn, SN-106279, sulcotrione, sulf-allate (CDEC), sulfentrazone, sulfometuron, sulfometuron-methyl, sulfosate (glyphosate-trimesium), sulfosulfuron, SYN-523, SYP-249, SYP-298, SYP-300, tebutam, tebuthiuron, tecnazene, tefuryltrione, tembotrione, tepraloxydim, terbacil, terbucarb, terbuchlor, terbumeton, terbuthylazine, terbutryn, TH-547 (propyrisulfuron), thenylchlor, thiafluamide, thiazafluoron, thiazopyr, thidiazimin, thidiazuron, thiencarbazone, thiencarbazone-methyl, thifensulfuron, thifensulfuron-methyl, thiobencarb, tiocarbazil, topramezone, tralkoxydim, tri-allate, triasulfuron, triaziflam, triazofenamide, tribenuron, tribenuron-methyl, tribufos, trichloroacetic acid (TCA), triclopyr, tridiphane, trietazine, trifloxysulfuron, trifloxysulfuron-sodium, trifluralin, triflusulfuron, triflusulfuron-methyl, trimeturon, trinexapac, trinexapac-ethyl, tritosulfuron, tsitodef, uniconazole, uniconazole-P, vernolate, ZJ-0166, ZJ-0270, ZJ-0543, ZJ-0862 and the following compounds:

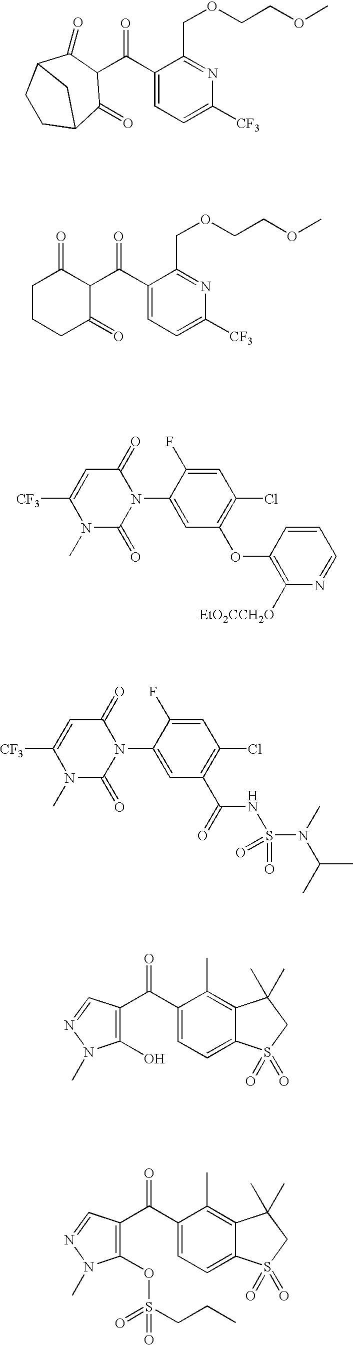

Preferred are herbicides such as bromoxynil, diflufenican, ethoxysulfuron, fenoxaprop, fenoxaprop-P, fenoxaprop-ethyl, fenoxaprop-P-ethyl, flufenacet, foramsulfuron, glufosinate, L-glufosinate, L-glufosinate-ammonium, glufosinate-ammonium, glyphosate, glyphosate-isopropylammonium, iodosulfuron, iodosulfuron-methyl-sodium, ioxynil, isoxaflutole, mecoprop, mecoprop-sodium, mecoprop-butotyl, mecoprop-P-butotyl, mecoprop-P-dimethylammonium, mecoprop-P-2-ethylhexyl, mecoprop-P-potassium, mefenacet, metosulam, metribuzin, propoxycarbazone, propoxycarbazone-sodium, tembotrione, thiencarbazone, thiencarbazone-methyl; and plant growth regulators such as cyclanilide, ethephon, tribufos and thidiazuron.

Examples of safeners are mefenpyr-diethyl, fenchlorazole-ethyl, isoxadifen-ethyl, cloquintocet, cloquintocet-mexyl, fenclorim, dichlormid, benoxacor, DKA-24, AD-67 (MON 4660), dicyclonon, furilazole, oxabetrinil, fluxofenim, cyometrinil (CGA-43089), flurazole, naphthalic anhydride, CL 304415, MG 191, TI-35, cyprosulfamide, 4-isopropylaminocarbonyl-N-(2-methoxybenzoyl)benzenesulfonamide and derivatives of dichlorophenylpyrazolecarboxylic acid (EP-A-333131 and EP-A-269806), compounds of the triazolecarboxylic acid type (EP-A-174562 and EP-A-346620), compounds of the (5-chloro-8-quinolinoxy)malonic acid type (EP-A-582198), active substances of the phenoxyacetic acid derivative or phenoxypropionic acid derivative type or of the aromatic carboxylic acid type (2,4-D, mecoprop, MCPA, dicamba), R-29148, PPG-1292, dimepiperate (MY-93), daimuron (SK 23), cumyluron (JC-940), methoxyphenone (NK 049), CSB (CAS No. 54091-06-4), N-acylsulfonamide (WO-A-97/45016).

Preferred are safeners such as mefenpyr-diethyl, cloquintocet-mexyl, isoxadifen-ethyl, 4-cyclopropylaminocarbonyl-N-(2-methoxybenzoyl)benzenesulfonamide (cyprosulfamide), 4-isopropylaminocarbonyl-N-(2-methoxybenzoyl)benzenesulfonamide or fenchlorazole-ethyl.

A particular embodiment of the present invention is the joint use of herbicides and safeners as mixtures in the formulations. The weight ratios of herbicide (mixture) to safener will generally depend on the application rate of herbicide and on the efficacy of the respective safener and may vary within wide limits, for example in the range of from 200:1 to 1:200, preferably from 100:1 to 1:100, in particular from 20:1 to 1:20.

Examples of Fungicides are:

nucleic acid synthesis inhibitors, in particular benalaxyl, benalaxyl-M, bupirimate, clozylacon, dimethirimol, ethirimol, furalaxyl, hymexazole, mefenoxam, metalaxyl, metalaxyl-M, ofurace, oxadixyl, oxolinic acid;
mitosis and cell division inhibitors, in particular benomyl, carbendazim, diethofencarb, ethaboxam, fuberidazole, pencycuron, thiabendazole, thiophanate-methyl, zoxamide; respiratory chain complex I inhibitors, in particular diflumetorim;
respiratory chain complex II inhibitors, in particular boscalid, carboxin, fenfuram, flutolanil, furametpyr, furmecyclox, mepronil, oxycarboxin, penthiopyrad, thifluzamid;
respiratory chain complex III inhibitors, in particular amisulbrom, azoxystrobin, cyazofamid, dimoxystrobin, enestrobin, famoxadon, fenamidone, fluoxastrobin, kresoxim-methyl, metominostrobin, orysastrobin, picoxystrobin, pyraclostrobin, trifloxystrobin;
decouplers, in particular dinocap, fluazinam, meptyldinocap; ATP production inhibitors, in particular fentin acetate, fentin chloride, fentin hydroxide, silthiofam;
amino acid and protein biosynthesis inhibitors, in particular andoprim, blasticidin-S, cyprodinil, kasugamycin, kasugamycin-hydrochloride hydrate, mepanipyrim, pyrimethanil;
signal transduction inhibitors, in particular fenpiclonil, fludioxonil, quinoxyfen;
fat and membrane synthesis inhibitors, in particular biphenyl, chlozolinate, edifenphos, etridiazole, iodocarb, iprobenfos (IBP), iprodione, isoprothiolane, procymidone, propamocarb, propamocarb hydrochloride, pyrazophos, tolclofos-methyl, vinclozolin;
ergosterol biosynthesis inhibitors, in particular aldimorph, azaconazole, bitertanol, bromuconazole, cyproconazole, diclobutrazole, difenoconazole, diniconazole, diniconazole-M, dodemorph, dodemorph acetate, epoxiconazole, etaconazole, fenarimol, fenbuconazole, fenhexamid, fenpropidin, fenpropimorph, fluquinconazole, flurprimidol, flusilazole, flutriafol, furconazole, furconazole-cis, hexaconazole, imazalil, imazalil sulfate, imibenconazole, ipconazole, metconazole, myclobutanil, naftifin, nuarimol, oxpoconazole, paclobutrazole, pefurazoate, penconazole, prochloraz, propiconazole, prothioconazole, pyributicarb, pyrifenox, simeconazole, spiroxamin, tebuconazole, terbinafin, tetraconazole, triadimefon, triadimenol, tridemorph, triflumizole, triforin, triticonazole, uniconazole, viniconazole, voriconazole;
cell wall synthesis inhibitors, in particular benthiavalicarb, dimethomorph, flumorph, iprovalicarb, mandipropamid, polyoxins, polyoxorim, validamycin A;
melanin biosynthesis inhibitors, in particular capropamid, diclocymet, fenoxanil, phthalide, pyroquilon, tricyclazole;
resistance inductors, in particular acibenzolar-S-methyl, probenazole, tiadinil;
multisite fungicides, in particular Bordeaux mixture, captafol, captan, chlorothalonil, copper naphthenate, copper oxide, copper oxychloride, copper preparations such as copper hydroxide, copper sulfate, dichlofluanid, dithianon, dodine, dodine free base, ferbam, fluorofolpet, folpet, guazatine, guazatine acetate, iminoctadin, iminoctadin albesilate, iminoctadin triacetate, mancopper, mancozeb, maneb, metiram, metiram zinc, oxine-copper, propineb, sulfur and sulfur preparations comprising calcium polysulfide, thiram, tolylfluanid, zineb, ziram;
fungicides selected from the group consisting of: (2E)-2-(2-{[6-(3-chloro-2-methyl-phenoxy)-5-fluoropyrimidin-4-yl]oxy}phenyl)-2-(methoxyimino)-N-methylacetamide, (2E)-2-{2-[({[(1E)-1-(3-{[(E)-1-fluoro-2-phenylvinyl]oxy}phenyl)ethylidene]-amino}oxy)methyl]phenyl}-2-(methoxyimino)-N-methylacetamide, 1-(4-chlorophenyl)-2-(1H-1,2,4-triazol-1-yl)cycloheptanol, 1-[(4-methoxyphenoxy)methyl]-2,2-dimethylpropyl 1H-imidazole-1-carboxylate, 1-methyl-N-[2-(1,1,2,2-tetrafluoroethoxy)phenyl]-3-(trifluoromethyl)-1H-pyrazole-4-carboxamide, 2,3,5,6-tetrachloro-4-(methyl-sulfonyl)pyridine, 2-butoxy-6-iodo-3-propyl-4H-chromen-4-one, 2-chloro-N-(1,1,3-trimethyl-2,3-dihydro-1H-inden-4-yl)nicotinamide, 2-phenylphenol and salts, 3-(difluoromethyl)-1-methyl-N-[2-(1,1,2,2-tetrafluoroethoxy)phenyl]-1H-pyrazole-4-carboxamide, 3-(difluoromethyl)-N-[(9R)-9-isopropyl-1,2,3,4-tetrahydro-1,4-methanonaphthalen-5-yl]-1-methyl-1H-pyrazole-4-carboxamide, 3-(difluoromethyl)-N-[(9S)-9-isopropyl-1,2,3,4-tetrahydro-1,4-methanonaphthalen-5-yl]-1-methyl-1H-pyrazole-4-carboxamide, 3-(difluoromethyl)-N-[4′-(3,3-dimethylbut-1-yn-1-yl)biphenyl-2-yl]-1-methyl-1H-pyrazole-4-carboxamide, 3,4,5-trichloropyridine-2,6-dicarbonitrile, 3-[5-(4-chlorophenyl)-2,3-dimethylisoxazolidin-3-yl]pyridine, 3-chloro-5-(4-chlorophenyl)-4-(2,6-difluorophenyl)-6-methylpyridazine, 4-(4-chlorophenyl)-5-(2,6-difluorophenyl)-3,6-dimethylpyridazine, 5-chloro-7-(4-methylpiperidin-1-yl)-6-(2,4,6-trifluorophenyl)[1,2,4]triazolo[1,5-a]pyrimidine, 8-hydroxyquinoline sulfate, benthiazole, bethoxazin, capsimycin, carvone, quinomethionate, cufraneb, cyflufenamid, cymoxanil, dazomet, debacarb, dichlorophen, diclomezine, dicloran, difenzoquat, difenzoquat methylsulfate, diphenylamine, ecomate, ferimzone, flumetover, fluopicolide, fluoroimide, flusulfamide, fosetyl-aluminum, fosetyl-calcium, fosetyl-sodium, hexachlorobenzene, irumamycin, isotianil, methasulfocarb, methyl (2E)-2-{2-[({cyclopropyl[(4-methoxyphenyl)imino]methyl}thio)methyl]phenyl}-3-methoxyacrylate, methyl 1-(2,2-dimethyl-2,3-dihydro-1H-inden-1-yl)-1H-imidazole-5-carboxylate, methylisothiocyanate, metrafenone, mildiomycin, N-(3′,4′-dichloro-5-fluorobiphenyl-2-yl)-3-(difluoromethyl)-1-methyl-1H-pyrazole-4-carboxamide, N-(3-ethyl-3,5,5-trimethylcyclohexyl)-3-(formylamino)-2-hydroxybenzamide, N-(4-chloro-2-nitrophenyl)-N-ethyl-4-methylbenzenesulfonamide, N-(4-chlorobenzyl)-3-[3-methoxy-4-(prop-2-yn-1-yloxy)phenyl]propanamide, N-[(4-chlorophenyl)(cyano)methyl]-3-[3-methoxy-4-(prop-2-yn-1-yloxy)phenyl]propanamide, N-[(5-bromo-3-chloropyridin-2-yl)methyl]-2,4-dichloronicotinamide, N-[1-(5-bromo-3-chloropyridin-2-yl)ethyl]-2,4-dichloronicotinamide, N-[1′-(5-bromo-3-chloropyridin-2-yl)ethyl]-2-fluoro-4-iodonicotinamide, N-[2-(1,3-dimethylbutyl)phenyl]-5-fluoro-1,3-dimethyl-1H-pyrazole-4-carboxamide, N-{(Z)-[(cyclopropylmethoxy)imino][6-(difluoromethoxy)-2,3-difluorophenyl]methyl}-2-phenylacetamide, N-{2-[1,1′-bi(cyclopropyl)-2-yl]phenyl}-3-(difluoromethyl)-1-methyl-1H-pyrazole-4-carboxamide, N-[2-[3-chloro-5-(trifluoromethyl)pyridin-2-yl]ethyl}-2-(trifluoromethyl)benzamide, natamycin, N-ethyl-N-methyl-N′-{2-methyl-5-(trifluoromethyl)-4-[3-(trimethylsilyl)propoxy]phenyl}imidoformamide, N-ethyl-N-methyl-N′-{2-methyl-5-(difluoromethyl)-4-[3-(trimethylsilyl)propoxy]phenyl}imidoformamide, nickel dimethyldithiocarbamate, nitrothal-isopropyl, O-{1-[(4-methoxyphenoxy)methyl]-2,2-dimethylpropyl}1H-imidazole-1-carbothioate, octhilinone, oxamocarb, oxyfenthiin, pentachlorophenol and salts, phosphoric acid and its salts, piperalin, propamocarb fosetylate, propanosine-sodium, proquinazid, pyribencarb, pyrrolnitrine, quintozene, S-allyl-5-amino-2-isopropyl-4-(2-methylphenyl)-3-oxo-2,3-dihydro-1H-pyrazole-1-carbothioate, tecloftalam, tecnazene, triazoxide, trichlamide, valiphenal, zarilamid.

Preferred are fungicides such as bitertanol, bromuconazole, carbendazim, carproamid, cyproconazole, edifenphos, fenanidone, fenhexamid, fentins, fluquinconazole, fosetyl-aluminum, iprodione, iprovalicarb, pencycuron, prochloraz, propamocarb HCl, propineb, pyrimethanil, spiroxamine, tebuconazole, tolylfluanid-dichlofluanid, triadimefon, triadimenol, trifloxystrobin.

Examples of insecticides, acaricides, nematicides are:

Acetylcholine esterase (AChE) inhibitors:
carbamates, for example alanycarb, aldicarb, aldoxycarb, allyxycarb, aminocarb, bendiocarb, benfuracarb, bufencarb, butacarb, butocarboxim, butoxycarboxim, carbaryl, carbofuran, carbosulfan, cloethocarb, dimetilan, ethiofencarb, fenobucarb, fenothiocarb, formetanate, furathiocarb, isoprocarb, metam-sodium, methiocarb, methomyl, metolcarb, oxamyl, pirimicarb, promecarb, propoxur, thiodicarb, thiofanox, trimethacarb, XMC, xylylcarb, triazamate;
organophosphates, for example acephate, azamethiphos, azinphos (-methyl, -ethyl), bromophos-ethyl, bromfenvinfos (-methyl), butathiofos, cadusafos, carbophenothion, chlorethoxyfos, chlorfenvinphos, chlormephos, chlorpyrifos(-methyl/-ethyl), coumaphos, cyanofenphos, cyanophos, chlorfenvinphos, demeton S-methyl, demeton S-methylsulfone, dialifos, diazinon, dichlofenthion, dichlorvos/DDVP, dicrotophos, dimethoate, dimethylvinphos, dioxabenzofos, disulfoton, EPN, ethion, ethoprophos, etrimfos, famphur, fenamiphos, fenitrothion, fensulfothion, fenthion, flupyrazofos, fonofos, formothion, fosmethilan, fosthiazate, heptenophos, iodofenphos, iprobenfos, isazofos, isofenphos, isopropyl O-salicylate, isoxathion, malathion, mecarbam, methacrifos, methamidophos, methidathion, mevinphos, monocrotophos, naled, omethoate, oxydemeton-methyl, parathion (-methyl/-ethyl), phenthoate, phorate, phosalone, phosmet, phosphamidon, phosphocarb, phoxim, pirimiphos (-methyl/-ethyl), profenofos, propaphos, propetamphos, prothiofos, prothoate, pyraclofos, pyridaphenthion, pyridathion, quinalphos, sebufos, sulfotep, sulprofos, tebupirimfos, temephos, terbufos, tetrachlorvinphos, thiometon, triazophos, triclorfon, vamidothion, imicyafos;
sodium channel modulators/voltage-dependent sodium channel blockers:
pyrethroids, for example acrinathrin, allethrin (d-cis-trans, d-trans), beta-cyfluthrin, bifenthrin, bioallethrin, bioallethrin-S-cyclopentyl isomer, bioethanomethrin, biopermethrin, bioresmethrin, chlovaporthrin, cis-cypermethrin, cis-resmethrin, cis-permethrin, clocythrin, cycloprothrin, cyfluthrin, cyhalothrin, cypermethrin (alpha-, beta-, theta-, zeta-), cyphenothrin, deltamethrin, empenthrin (1R isomer), esfenvalerate, etofenprox, fenfluthrin, fenpropathrin, fenpyrithrin, fenvalerate, flubrocythrinate, flucythrinate, flufenprox, flumethrin, fluvalinate, fubfenprox, gamma-cyhalothrin, imiprothrin, kadethrin, lambda-cyhalothrin, metofluthrin, permethrin (cis-, trans-), phenothrin (1R trans isomer), prallethrin, profluthrin, protrifenbute, pyresmethrin, resmethrin, RU 15525, silafluofen, tau-fluvalinate, tefluthrin, terallethrin, tetramethrin (−1R isomer), tralomethrin, transfluthrin, ZXI 8901, pyrethrins (pyrethrum), eflusilanate; DDT;
oxadiazines, for example indoxacarb;
semicarbazones, for example metaflumizone (BAS320 I);
acetylcholine receptor agonists/antagonists:
chloronicotinyls, for example acetamiprid, clothianidin, dinotefuran, imidacloprid, imidaclothiz, nitenpyram, nithiazine, thiacloprid, thiamethoxam, AKD-1022;
nicotine, bensultap, cartap, thiocylam;
acetylcholine receptor modulators:
spinosyns, for example spinosad, spinetoram;
GABA-controlled chloride channel antagonists:
organochlorines, for example camphechlor, chlordane, endosulfan, gamma-HCH, HCH, heptachlor, lindane, methoxychlor;
fiproles, for example acetoprole, ethiprole, fipronil, pyrafluprole, pyriprole, vaniliprole;
chloride channel activators:
mectins/macrolides, for example abamectin, emamectin, emamectin-benzoate, ivermectin, lepimectin, milbemycin;
juvenile hormone mimetics:
for example diofenolan, epofenonane, fenoxycarb, hydroprene, kinoprene, methoprene, pyriproxifen, triprene;
ecdysone agonists/disruptors:
diacylhydrazines, for example chromafenozide, halofenozide, methoxyfenozide, tebufenozide;
chitin biosynthesis inhibitors:
benzoylureas, for example bistrifluoron, chlofluazuron, diflubenzuron, fluazuron, flucycloxuron, flufenoxuron, hexaflumuron, lufenuron, novaluron, noviflumuron, penfluoron, teflubenzuron, triflumuron;
buprofezin;
cyromazine;
inhibitors of oxidative phosphorylation, ATP disruptors:
diafenthiuron;
organotin compounds, for example azocyclotin, cyhexatin, fenbutatin oxide, tetradifon. uncouplers of oxidative phosphorylation by interrupting the H proton gradient:
pyrroles, for example chlorfenapyr;
dinitrophenols, for example binapacryl, dinobuton, dinocap, DNOC, meptyldinocap;
sited electron transport inhibitors:
METIs, for example fenazaquin, fenpyroximate, flufenerim, pyrimidifen, pyridaben, tebufenpyrad, tolfenpyrad;
hydramethylnon;
dicofol;
site-II electron transport inhibitors:
cyenopyrafen, cyflumetofen, rotenone;
site-III electron transport inhibitors:
acequinocyl, fluacrypyrim;
microbial disruptors of the insect gut membrane:
Bacillus thuringiensis strains;
lipid synthesis inhibitors:
tetronic acids, for example spirodiclofen, spiromesifen;
tetramic acids, for example spirotetramate, cis-3-(2,5-dimethylphenyl)-4-hydroxy-8-methoxy-1-azaspiro[4.5]dec-3-en-2-one; octopaminergic agonists:
for example amitraz;
inhibitors of magnesium-stimulated ATPase:
propargite;
nereistoxin analogues, for example thiocyclam hydrogen oxalate, thiosultap-sodium;
ryanodin receptor agonists:
benzoic acid dicarboxamides, for example flubendiamide;
anthranilamides, for example chloranthraniliprole (rynaxypyr, 3-bromo-N-{4-chloro-2-methyl-6-[(methylamino)carbonyl]phenyl}-1-(3-chloropyridin-2-yl)-1H-pyrazole-5-carboxamide);
biologicals, hormones or pheromones:
azadirachtin, Bacillus spec., Beauveria spec., codlemone, Metarrhizium spec., Paecilomyces spec., thuringiensin, Verticillium spec. active substances with unknown or unspecific mechanisms of action:
gassing agents, for example aluminum phosphide, methyl bromide, sulfuryl fluoride;
antifeedants, for example flonicamid, pymetrozine, pyrifluquinazone;
mite growth inhibitors, for example clofentezine, diflovidiazin, etoxazole, hexythiazox, amidoflumet, benclothiaz, benzoximate, bifenazate, bromopropylate, buprofezin, quinomethionate, chlordimeform, chlorobenzilate, chloropicrin, clothiazoben, cycloprene, dicyclanil, fenoxacrim, fentrifanil, flubenzimine, flutenzin, gossyplure, hydramethylnone, japonilure, metoxadiazone, petroleum, piperonyl butoxide, potassium oleate, pyridalyl, sulfluramid, tetradifon, tetrasul, triarathene, verbutin.

Preferred are insecticides such as acetamiprid, acrinathrin, aldicarb, amitraz, azinphos-methyl, beta-cyfluthrin, carbaryl, cyfluthrin, cypermethrin, deltamethrin, endosulfan, ethoprophos, fenamiphos, fenthion, imidacloprid, methamidophos, methiocarb, niclosamide, oxydemeton-methyl, phosalone, prothiophos, silafuofen, thiacloprid, thiodicarb, tralomethrin, triazophos, trichlorfon, triflumuron; very especially preferably from the group consisting of chloronicotinyls such as acetamiprid, clothianidin, dinotefuran, imidacloprid, nitenpyram, nithiazine, thiacloprid, thiamethoxam, in particular thiacloprid.

Preferred plant protectant active substances (agrochemical active substances) are diflufenican, ethoxysulfuron, flufenacet, glufosinate, L-glufosinate, L-glufosinate-ammonium, glufosinate-ammonium, glyphosate, glyphosate-isopropylammonium, iodosulfuron, iodosulfuron-methyl-sodium, mefenpyr-diethyl, cloquintocet-mexyl, isoxadifen-ethyl, cyprosulfamide, tebuconazole, fluquinconazole, imidacloprid and thiacloprid.

The proportion of plant protectant active substances selected from the group of the herbicides, safeners, insecticides and fungicides (agrochemical active substances) in the active substance granule particles according to the present invention depends on the customary dosage rates required for an effect and can, therefore, vary as a function of the crop. In general, the proportion can therefore amount to from 0.001-90% by weight, preferably from 0.01-70% by weight, especially preferably from 0.1-50% by weight, based on the active substance granule particles.

The application rates per unit area of the agrochemical active substances are generally between 0.5 and 2000 g AS/ha (AS=active substance, i.e. application rate based on the active substance), preferably between 1 and 1000 g AS/ha.

Although what has been said above has focused on water-dispersible granule particles (WG), this also applies according to the invention to nondispersible granule particles. The term “granule particle” refers to individual granules which are present in the form of granule grains, synonymously also referred to as “granulates”. The term granule particles encompasses all suitable types of granule formulations (letter codes according to “Catalogue of Pesticide Formulation Types and International Coding System, Technical monograph No. 2, 5th Edition, March 2002; CropLife International, Brussels, Belgium; see “The Pesticide Manual”, 14th Edition 2006/2007, or “e-Pesticide Manual”, version 4, 2006), such as, for example, WG (water dispersible granule), GR (granule), SG (water soluble granule), MG (microgranule), GG (macrogranule), but also other suitable types of formulations, such as, for example, WP (wettable powder).

The term “with a spherical to lump-like shape” means that the active substance granule particles referred to thus are approximately spherical (synonymously also referred to as “essentially isodimensional shape”). The granule particles according to the present invention are characterized by a largely spherical to lump-like shape (“popcorn-like agglomerates”) and mostly have diameters (cross-section widths) of essentially 45 μm to 2 mm. The diameters of the spherical to lump-like granule particles and their uniformity have an important effect on the possibility of the granule particles separating out in the mixture pack to be. The processes for the preparation of the spherical to lump-like granule particles here advantageously allow a high degree of control over the diameter and the uniformity and thus allow these parameters (for example separation of the granule particle sizes after preparation) to be set within the normal production flow.

The suitable processes for the preparation of the spherical to lump-like granule particles include all agglomeration (granulation) processes, such as, for example, fluidized bed (fluid bed), plate, disk, high shear rates (also known as the Schugi process), spray drying and the like, but also paste extrusion, where the extrudate is aftertreated in order to be imparted a spherical to lump-like shape (for example WO 89/00079). The granule particles prepared by these processes are generally subsequently graded by screening in order to adjust the diameter and the uniformity of the granule particles. The “oversize” and “fines” fractions removed by screening in the process are then frequently reprocessed in the course of the further production.

The preparation of the spherical to lump-like granule particles for example by the fluidized-bed method consists in the preparation of a slurry. To this end, water is introduced into a vat and stirred. Antifoam agents and formulation adjuvants are added, followed by active substance(s) and granule carriers. All this is mixed until a homogeneous slurry has been obtained. This slurry is then wet-milled, for example using a ball mill, until the desired particle diameter has been obtained. Further processing is then carried out by the fluidized-bed method by drying the slurry after injecting into a fluidized-bed dryer. Thereafter, the “oversize” and “fines” fractions are removed by screening.

The preparation of the spherical to lump-like granule particles for example by the high-shear method consists in the pulverulent premix. To this end, all constituents and active substances are mixed with granule carriers and subsequently dry-milled until the desired particle diameter has been obtained. Further processing is then carried out by filling a “Schugi” granulation apparatus (high-shear method) with the premix and injecting water. The agglomerated premix is then dried in a fluidized-bed dryer. Again, thereafter, the “oversize” and “fines” fractions are removed by screening.

Agglomeration (granulation) processes allow spherical to lump-like granule particles to be generated which are highly uniform between batches and even between products in respect of their shape. Owing to their spherical to lump-like shape, the granule particles can be graded outstandingly by screening in order to remove the “oversize” and “fines” fractions, which hinder a homogeneous mixture and which cause separation in the mixture pack to be.

All the adjuvants and additives required for the preparation of spherical to lump-like granule particles, including their dosage rates, will vary as a function of the intended purpose. They are generally known to the skilled worker and are described, for example, in: Winnacker-Küchler, “Chemische Technologie [Chemical Technology]”, volume 7, C. Hanser Verlag Munich, 4th Edition 1986, Wade van Valkenburg, “Pesticide Formulations”, Marcel Dekker, N.Y., 1973; K. Martens, “Spray Drying” Handbook, 3rd Ed. 1979, G. Goodwin Ltd. London; Watkins, “Handbook of Insecticide Dust Diluents and Carriers”, 2nd Ed., Darland Books, Caldwell N.J., H. v. Olphen, “Introduction to Clay Colloid Chemistry”; 2nd Ed., J. Wiley & Sons, N.Y.; C. Marsden, “Solvents Guide”; 2nd Ed., Interscience, N.Y. 1963; McCutcheon's “Detergents and Emulsifiers Annual”, MC Publ. Corp., Ridgewood N.J.; Sisley and Wood, “Encyclopedia of Surface Active Agents”, Chem. Publ. Co. Inc., N.Y. 1964; Schonfeldt, “Grenzflächenaktive Äthylenoxidaddukte [Interface-active ethylene oxide adducts]”, Wiss. Verlagsgesell., Stuttgart 1976; Winnacker-Küchler, “Chemische Technologie”, volume 7, C. Hanser Verlag Munich, 4th Edition 1986.

Likewise generally known to the skilled worker are the preparation processes for generating the mixtures of different plant protectant active substance granule particles with a spherical to lump-like shape, hereinbelow also referred to “mixture packs”. Simple processes may be used, such as, for example, the use of a drum mixer, or else specific mixing apparatuses as described, for example, in WO 94/24861 A1. What is decisive here is that no, or only a low degree of, friction prevails between the granule particles during the mixing operation.

In this context, the granule particles may be water-dispersible, water-soluble and/or nondispersible. What is of particular importance here is also the specific gravity of the individual plant protectant active substance granule particles, the rule being that, besides the other abovementioned specifications, suitably high specific gravities with in general more than 45 g/100 ml granule volumes, in particular over 60 g/100 ml, are required for homogeneous mixture packs which will no longer be capable of separation. In addition, minor differences with regard to specific gravity are advantageous for homogeneous mixture packs which are no longer capable of separation.

Thus, mixture packs of spherical to lump-like granule particles composed of at least two or more different plant protectant active substance granule particles can be prepared whose composition is no longer capable of separation and which therefore remain homogeneous upon storage, handling and application. They can then be metered uniformly according to the present invention, which makes possible a simplified preparation of a wide range of mixing ratios in order to satisfy the demands of the different markets and thus to solve many packaging and stocking problems.

Surprisingly, it has emerged that mixing-incompatible plant protectant active substances can be mixed with each other in a storage-stable manner by using the above-mentioned homogeneous mixture packs (mixtures of different plant protectant active substance granule particles, advantageously with a spherical to lump-like shape). This therefore allows the use according to the invention of these mixture packs for plant protectant active substances which had previously shown to be “incompatible” in mixture with other active substances on or in a granule particle. Determining the “incompatibility” of individual active substances in an active substance mixture is effected by simply measuring the remaining residual amounts of active substance after a predetermined storage period. The reasons for this active substance “incompatibility” with other active substances may be based on a very wide range of factors. However, it poses a serious problem for formulation research, when active substance mixtures required by the market cannot be realized due to this problem.

As regards the process for the preparation of mixtures of plant protectant active substances in the form of granules for mixing-incompatible active substances, all processes for the preparation of the granule particles may be used in principle. Thus, besides the above-described processes, it is also possible to employ other processes such as, for example, extrusion processes which give cylindrical granule particles. However, granule particles with a spherical to lump-like shape are preferred, and especially preferred are granule particles with a spherical to lump-like shape whose majority has a diameter of 45 μm to 2 mm. In addition, it is advantageous for the specific gravity of the individual plant protectant active substance granule particles to exceed 45 g/100 ml granule volume.

The examples which follow are intended to illustrate the invention, but not to impose any limitation.

TABLE 1
Specific gravity and diameter fractions of individual active substance
granules and of a mixture prepared therefrom (mixture pack)

| Parameter | Granules 1 | Granules 2 | Granules 1 + 2 |
|---|---|---|---|
| Specific gravity [g/100 ml] | 71-75 | 60-64 | 63-68 |
| Dry screening [%] | 0.0 | 0.0 | 0.0 |
| Diameter > 2.000 mm | | | |
| Dry screening [%] | 0.6 | 3.4 | 1.5 |
| Diameter 2.000-1.000 mm | | | |
| Dry screening [%] | 29.9 | 29.3 | 12.4 |
| Diameter 1.000-0.500 mm | | | |
| Dry screening [%] | 69.5 | 1.0 | 0.5 |
| Diameter 0.500-0.080 mm | | | |
| Dry screening [%] | 0.03 | 67.7 | 86.0 |
| Diameter < 0.080 mm | | | |

Key:
Granules 1: WG-type comprising diflufenican (36% by weight) and iodosulfuron-sodium (1% by weight), preparation: fluidized-bed method;
Granules 2: WG-type comprising flufenacet (60% by weight), preparation: high-shear process;
Granules 1 + 2: mixture of 10 g granules 1 with 20 g granules 2, mixed for 2 hours in a tumble mixer.

TABLE 2
Comparative experiment - storage of a granule mixture (1)
and a granule coformulation (2) with identical active
substance composition

| | | | |
|---|---|---|---|
| | Absolute | Absolute | Percentage |
| | content at | content after | change |
| | the | 2 months' | after 2 |
| | beginning | storage at | months' |
| | of the | 40° C. | storage at |
| | storage [% | [% by | 4° C. |
| Active substances | by weight] | weight] | [+/− %] |

Granule mixture (1) - according to the invention

| | | | |
|---|---|---|---|
| Flufenacet | 39.8 | 39.2 | −1.5 |
| | 40.0 | 38.3 | −4.3 |
| | 40.6 | 39.9 | −1.7 |
| Diflufenican | 12.5 | 12.8 | +2.4 |
| | 12.3 | 12.1 | −2.0 |
| | 12.1 | 12.1 | 0.0 |
| Iodosulfuron | 0.330 | 0.367 | +11.2 |
| | 0.312 | 0.360 | +15.4 |
| | 0.378 | 0.382 | +1.1 |
| pH | 3.6 | 3.7 | — |

Granule coformulation (2) - prior art

| | | | |
|---|---|---|---|
| Flufenacet | 12.40 | 12.10 | −2.4 |
| Diflufenican | 3.79 | 3.79 | 0.0 |
| Iodosulfuron | 0.135 | 0.039 | −71.0 |
| pH | 3.8 | 3.9 | — |

Key:
(1) Granule mixture composed of a) WG comprising diflufenican and iodosulfuron-sodium and b) WG comprising flufenacet, n = 3;
(2) WG coformulation comprising diflufenican, iodosulfuron-sodium and flufenacet, n = 1.

The data of the comparative experiment in Table 2 demonstrate that the active substance iodosulfuron is subject to severe degradation during storage when using the granule coformulation (prior art). When using the granule mixture (according to the invention), no appreciable change in the iodosulfuron content can be ascertained, within the range of variation.

We claim:

1. The use of mixtures of different plant protectant active substance granule particles with a spherical to lump-like shape which remain homogeneous upon storage, handling and application, for the stable storage of mixing-incompatible active substances.

2. The use as claimed in claim 1, wherein the plant protectant active substances are selected from the group consisting of herbicides, safeners, fungicides and insecticides.

3. The use as claimed in claim 1 or 2, wherein the plant protectant active substances are selected from the group consisting of diflufenican, ethoxysulfuron, flufenacet, glufosinate, L-glufosinate, L-glufosinate-ammonium, glufosinate-ammonium, glyphosate, glyphosate-isopropylammonium, iodosulfuron, iodosulfuron-methyl-sodium, mefenpyr-diethyl, cloquintocet-mexyl, isoxadifen-ethyl, cyprosulfamide, tebuconazole, fluquinconazole, imidacloprid and thiacloprid.

4. The use as claimed in one or more of claims 1 to 3, wherein the majority of the granule particles with a spherical to lump-like shape has a diameter of from 45 μm to 2 mm.

5. The use as claimed in one or more of claims 1 to 4, wherein the specific gravity of the individual plant protectant active substance granule particles exceeds 45 g/100 ml granule volume.

6. A process for the preparation of mixtures of plant protectant active substances in the form of granules for mixing-incompatible active substances, which comprises formulating the mixing-incompatible active substances, alone or together with mixing-compatible active substances, initially in each case separately as granule particles of one group, which are then subsequently mixed with each other.

7. The process as claimed in claim 6, wherein the plant protectant active substances are selected from the group consisting of herbicides, safeners, fungicides and insecticides.

8. The process as claimed in claim 6 or 7, wherein the granule particles have a spherical to lump-like shape.

9. The process as claimed in one or more of claims 6 to 8, wherein the majority of the granule particles with a spherical to lump-like shape has a diameter of from 45 μm to 2 mm.

10. The process as claimed in one or more of claims 6 to 9, wherein the specific gravity of the individual plant protectant active substance granule particles exceeds 45 g/100 ml granule volume.
